(19) United States
(12) Patent Application Publication
(10) Pub. No.: US 2024/0062264 A1
(43) Pub. Date: Feb. 22, 2024

(54) AI- BACKED E-COMMERCE FOR ALL THE TOP RATED PRODUCTS ON A SINGLE PLATFORM

(71) Applicant: Abhishek Trikha, Bonney Lake, WA (US)

(72) Inventor: Abhishek Trikha, Bonney Lake, WA (US)

(21) Appl. No.: 17/499,932

(22) Filed: Oct. 13, 2021

(51) Int. Cl. G06Q 30/06; G06N 20/00; G06Q 30/02

(52) U.S. Cl. CPC G06Q 30/0625; G06N 20/00; G06Q 30/0282

(57) ABSTRACT

The present method is an AI powered e-commerce platform for selling of only top reviewed and top rated products. The AI of present e-commerce platform analyzes truthfulness or falsity of reviews over the product by pulling the product reviews from the e-commerce platform and analyzes the same using the computer implemented tools to determine the authenticity of each and every review over the products on said e-commerce platform thus, providing the genuinely top rated and high quality products to the buyers.

### FIELD OF INVENTION

The present invention generally relates to electronic commerce commerce) websites, and more specifically relates to selecting products based on AI enabled e-commerce store/website which compiles all the top rated products on a single platform for consumers, which are highly relevant and targeted.

### BACKGROUND OF THE INVENTION

The quantity of products provided for sale in physical retail establishment is inherently limited by the physical space occupied by the retail establishment. Being unbound by such physical constraints, e-commerce websites may therefore offer an almost unlimited number of products for sale. Consumers may become frustrated with the limitless number of products with which they are presented. Often times, many of the products presented to the consumer are irrelevant to the wants, desires, and, or preferences of the consumer. Additionally, physical retail establishment may utilize merchandising techniques to ensure proper product placement of items within the retail environment. These merchandising activities can increase the likelihood that a consumer may purchase a product. E-Commerce websites are currently limited in their merchandising capabilities because the amount of products and/or associated merchandising that can be presented to the consumer at one time is limited by the dimensions of the display device (e.g., computer screen) with which the consumer is interacting. Therefore, the space needs to be filled with appropriately targeted products to maximize product conversions.

Moreover, offering relevant products is becoming increasingly important for e-commerce companies in order for them to effectively attract and retain consumers given the ever increasing number of competitors emerging on the internee. As consumers are faced with an overwhelming selection of products, content, and service online, companies are faced with an equal level of decision complexity in order to effectively determine which of their ever expansive inventory of products should be offered to a consumer population the vast majority, of which are anonymous visitors of their online stores.

The standard approaches used by e-commerce websites to target customer is based on multivarities analysis. Moreover, there are too many different features/criteria to compare, concerns about where the product was created, safety, quality and durability and so many other things to consider. Moreover, to find the best product most of the people rely on reviews (user's feedback) and expert opinion. It takes multiple hours to find a good platform researching multiple platforms and reading multiple reviews. Some of these reviews can be fake and there is lot of biased information. There are few inventions that describe different system and method for recommending products based on ranking. Few describes method for detecting spam reviews written on websites, validating product recommendation system and methods but none of them describe an AI based e-commerce platform having top rated products based on user's true feedback and expert guidance.

For example, U.S. Pat. No. 8,027,865 describes a system and methods which enable modeling of end consumer interests based, on online activity and producing e-commerce reports is described. The method includes scoring and classifying interests and preferences of consumers in relation to various items being offered as function of time and utilizing such scores to predict purchasing activity and revenue yield for n-dimensional combinations of interest for generation of consumer lists for target marketing and merchandising. The method also includes converse modeling of the performance and behavioral profile of items offered as a function of consumer activity. This Abstract is provided for the sole purpose of complying with the rules that allow a reader to quickly ascertain the subject matter of the disclosure contained herein. This Abstract is submitted with the explicit understanding that it will not be used to interpret or to limit the scope or the meaning of the claims.

Furthermore, US 20170221111 describes a method for detecting if an online review written by a user on a website of a telecommunications network is a spam, using at least one previously-labeled review, a review dataset comprising at least one review to be analyzed, and a spam feature list listing different features of spam reviews, method wherein: a) a weight is computed for each spam feature of the spam feature list, corresponding to the importance of the spam feature in the detection of spam reviews, and based at least on the features of said at least one previously-labeled review, and b) a probability of being a spam for a review under analysis in the review dataset is computed by using at least the weights of the spam features computed at step a) and a comparison between the features of said review under analysis and the ones of at least one review previously-labeled as spam.

Moreover, U.S. Pat. No. 9,773,270 discloses a systems and methods for e-commerce personalization and merchandising are provided herein. In some instances, methods may include determining triggers for a consumer, where the triggers being associated with objective consumer preferences and subjective consumer preferences for the consumer. Also, the method includes selecting a ranking cocktail for the consumer that includes a plurality of attributes that each includes a weight. The method also includes utilizing the ranking cocktail to select recommended products from an inventory of products in a database of a merchant, and providing the recommended products for display to the consumer.

Thus, it would be desirable to have a single platform with all the top rated reviewed products (user's feedback), reviews for truthfulness through customized AI and expert guidance on a single platform. This way the user do not have to search for endless hours to find the best product.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The present invention satisfies the needs and alleviate the problems discussed above. The purpose of this invention is to build an AI enabled e-commerce store that compiles ail the top rated products on a single platform.

According to one aspect, the invention is directed to a method for providing recommended products to a consumer using a product recommendation system. The invention is capable of being used to have access to all the genuine top rated products filtered through AI along with expert guidance on a single platform.

According to another aspect of the invention, the present disclosure is directed to a method for generating true reviews by filtering fake reviews by customizable AI for each department includes: (1) dividing reviews (2) labeling review text and dividing them based on the label (3) converting each group of raw documents to a matrix of term frequency-inverse document frequency (TF-IDF) (4) dividing each feature set into 5 folds, using 4 folds for training leaving 1 as testing set (5) for each feature set using Support Vector Machine (SVM) parameters (6) getting SVM models for each feature set (7) classifying new reviews into groups and then using 5 SVM models to have the probabilities for the review, which in turn gives the result for fake or true review.

### BRIEF DESCRIPTION OF THE DRAWINGS

The foregoing and other objects, features, and advantages of the devices and systems described herein will be apparent from the following description of particular embodiments thereof, as illustrated in the accompanying figures.

FIG. 1 illustrates a block diagram of computing architecture that may be utilized to practice aspects of the present technology.

FIG. 2 is a flowchart of an exemplary method of providing filtered reviews for a product recommendation system.

### DETAILED DESCRIPTION OF INVENTION

Various embodiments of the disclosure are discussed in detail below. While specific implementations are discussed, it should be understood that this is done for illustration purposes only. A person skilled in the relevant art will recognize that other components and configurations may be used without departing from the scope of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the term “System” when used in this specification, is used to specify “AI System”.

Broadly speaking, the present technology may be utilized to present highly relevant products to consumers via an e-commerce website. Using the present technology, marketers and merchants may display the highly relevant item(s), to appropriate consumers, at the right time, in order to maximize product sales. The present invention uses AI based e-commerce store which compiles all the top rated products on a single platform. The core components of the invention are compilation of a top reviewed products from internet at one place where fake reviews are filtered by customizable AI for each department.

In one embodiment, the AI algorithm is trained on existing reviews to identify the genuine review based on different criteria including purchase confirmation, frequency of posting reviews by a single user, and many other heuristic conditions. This process is to make final dataset of genuine reviews from multiple review dataset. In another embodiment of the invention, review dataset initially undergoes pre-processing by removing non-English characters, punctuations, lemmatisation [reducing the word to its root form], and removal of numbers from the dataset. The processed results are again processed to ensure that there is a balanced dataset. In another embodiment, the balanced dataset has equal number of genuine and not genuine/fake reviews. Extra care is taken to include maximum number of product reviews belonging to pets for the training of the AI algorithm.

In another embodiment of the invention, the filtered dataset is used for getting the probability of being fake by using LSTM model or deep neutral network. These networks are used for classifying, processing and making predictions based on series data. This data and model will be updated on regular basis, to identify the new fake reviews of the products involved. In another embodiment, with the additional use of NLP techniques and deep neutral networks, the method provides 90% identification of authentication of genuine reviews.

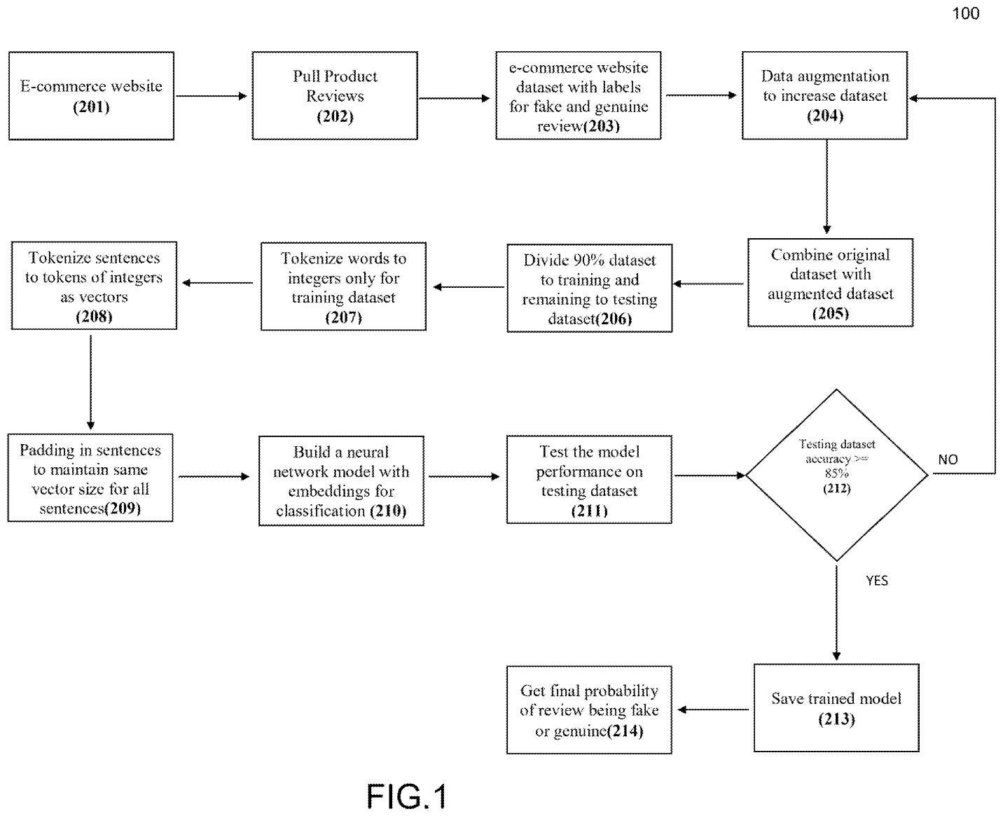

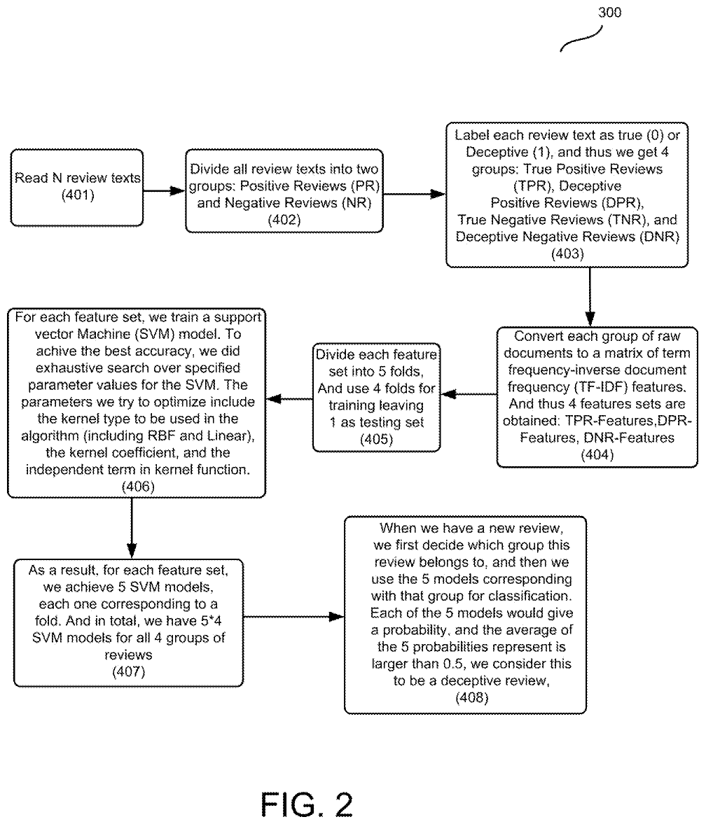

FIG. 1 is a block diagram of exemplary architecture 100 construed in accordance with various embodiment of the present technology. The architecture 100 includes an e-commerce website 201. The AI system pulls product reviews 202 from e-commerce websites 201 and analyzes product reviews based on the language of the reviews of previous old fake and genuine reviews. According to one embodiment, the website uses fakespot, reviewMeta and Reviewindex to analyze the product reviews. The method for analyzing truthfulness and falsity of the reviews 300 is described in greater detail with regards to FIG. 2.

In one of the embodiment, the architecture 100 further uses text augmentation libraries 204 which can augment a single sentence with similar meaning to 10 different sentences, which will enhance the word index for identifying new reviews which may have similar words. Once the data augmentation is done, it is combined with original dataset 205. This dataset is divided into training and testing dataset 206. The tokenization of the words is done only for the training dataset and out of vocabulary words are taken into the consideration 207. Then the sentences are converted to vectors of integers, and this process is like corpus in NLTK library, padding is done such that all the vectors are of same size 209.

In another embodiment, the neural network with embedding is built for classification of the dataset into either genuine or fake review 210. This model is tested for accuracy, and neural network is run for 100 times, and this process will stop automatically when there is no further improvement in the accuracy of the model with the testing data for more than 5 times 212. If the accuracy of model for testing data is less than 85%, then we either improve the neural network architecture or improve the data augmentation 212. If the model can accurately predict the results for more than 85% of the dataset, along with accuracy with precision, recall is more than 85% of the data, then the system will save the model. This model can be used future prediction of new reviews from e-commerce websites 214.

In another embodiment of the invention, for more accuracy of the fake and authentic reviews, the algorithm uses training dataset from Over the top (OTT). This dataset includes 400 true reviews selected from selected websites as well as 400 deceptive reviews manually created using Mechanical Turk (MTurk). On the training dataset, NLP uses tokenized words and support vector machine classifier as a classifier model. Further the information of product review, user id, verified purchase etc is taken into consideration in order to understand the probability of a new database being fake. Based on this probability a deep neural network or recurrent neural network or LSTM in order build a deep learning model. This data and model will be updated on regular basis, to identify the new fake reviews of the products involved. With adding more variables into the mix, using NLP, and deep neural network, the proposal is to achieve around 90% accuracy for the identification of authenticity of the product reviews in the e-commerce platforms.

FIG. 2 is a flowchart of an exemplary method 300 providing filtered reviews for a product recommendation system. The system reads and reviews the texts 401. All the reviews are divided into two groups: positive review and negative reviews 402. The system labels each review text as true (0) or deceptive (1), thus, dividing the reviews in 4 groups: (1) true positive reviews (TPR) (2) deceptive positive reviews (DPR), true negative reviews (TNR) and deceptive negative reviews (DNR) 403. The system further converts each group of raw documents to a matrix of term frequency-inverse document frequency (TF-IIF) features. Conversion of the group provides 4 feature sets: TPR features, DPR Features, TNR features and DNR features 404.

In another embodiment of the invention, the converted features of 404 are then divided into 5 folds, out of which 4 folds are used for training leaving 1 as a testing set 405. The system for each feature set, trains support vector machine (SVM) model. The system uses kernel type parameters to be used in the algorithm (including RBF and Linear), the kernel coefficient, and the independent term in kernel function 406.

In one more embodiment of the invention, for each feature set of 405, after applying the SVM parameters of 406, the system achieves 5 SVM models, each one corresponding to a fold. Thus, having 5*4 SVM models for all 4 groups of review in the end 407. At last, when the system has new review, the system decides a group in which the review belongs to and then 5 models corresponding with that group will be used to classify. Each of the 5 models give a probability and whichever review gets average probabilities larger than 0.5 is considered to be a deceptive review 408.

In one more embodiment of the invention, the system compiles all the top rated products from the internet to a single platform based on the filtered customer's review system 300 and expert guidance. In one embodiment, with basic deep neural network with the training dataset from OTT papers, the system is able to achieve around 70% accuracy. With addition more variables into the mix, using NLP, and deep neural network, the system is to achieve around 90% accuracy for the identification of authenticity of the product reviews in the e-commerce platforms.

1. A computer-implemented method for displaying a genuine top-rated relevant products to a consumer, the method comprising:
providing a processing circuitry configured to predict probability of a review of a product being authentic having
a neural network having a training dataset including a plurality of true reviews selected from a plurality of e-commerce stores and websites, a plurality of deceptive reviews manually created using Mechanical Turk (MTurk) and the review of the product as an input data, and a result of a classified review of the product as an output data; and
a machine learning assembly configured to train the neural network for the output data by using the input data as a training data, and
configured to:
enter the input data to the neural network learned by the machine learning assembly as a reference;
predict the probability of a review of the product being authentic; and
display the genuine top-rated product for the consumer.

2. The method of claim 1, wherein a review text of the collected authentic and fake reviews are labelled and divided based on a label.

3. The method of claim 2, wherein the label for the review text is either true (0) or deceptive (1).

4. The method of claim 3, wherein the labelling of the review text divides the reviews in four groups including a (1) true positive reviews (TPR), a (2) deceptive positive reviews (DPR), a (3) true negative reviews (TNR) and a (4) deceptive negative reviews (DNR).

5. The method of claim 1 further includes step of converting each of the four groups to a matrix of term frequency-inverse document: frequency (TF-IDF) to generate four feature sets.

6. The method of claim 5, wherein the four feature sets including a true positive reviews (TPR) features, deceptive positive reviews (DPR) Features, true negative reviews (TNR) features, and deceptive negative reviews (DNR) features.

7. The method of claim 6, wherein the four feature sets are then divided in a five (5) folds, out of which 4 folds are selected as training data and remaining 1 fold is used as a testing set.

8. The method of claim 7 further includes step of applying a support vector machine (SVM) parameters to achieve a 5 SVM models, each one corresponding to one of the five folds, thus having 5*4 SVM models for four groups of review.

9. The method of claim 8, wherein each of the 5 SVM model gives a probability and if the review gets an average probability larger than 0.5 is considered to be a deceptive review.

10. (canceled)

11. (canceled)

12. The method of claim 1, wherein the processing circuitry further uses the criteria including a purchase confirmation, and a frequency of posting review by a single user to identify the genuine review of the product.
